(19) United States
(12) Patent Application Publication
(10) Pub. No.: US 2002/0000742 A1
(43) Pub. Date: Jan. 3, 2002

(54) Vehicle seat sensor

(75) Inventors: Koji Wato, Obu-city (JP); Takaaki Yamamoto, Okazaki-city (JP); Hiroyuki Ito, Chita-city (JP)

Correspondence Address: Pillsbury winthrop LLP, East Tower, Ninth Floor, 1100 New York Avenue, N.W., Washington, DC, 20005-3918, US

(73) Assignee: DENSO CORPORATION, Kariya-city (JP)

(21) Appl. No.: 09/873,296

(22) Filed: Jun. 5, 2001

(30) Foreign Application Priority Data
Jun. 28, 2000 (JP) 2000-195137

(51) Int. Cl. B60R 21/00

(52) U.S. Cl. 297/216.1

(57) ABSTRACT

To provide a vehicle seat sensor wherein the sensor mat is kept stabilized by a soft flexible stabilizing member such as foamed material. A sensor mat is sandwiched between a soft film stabilizing member.

### CROSS-REFERENCE TO RELATED APPLICATION

The present invention is related to Japanese patent application No. 2000-195137, filed Jun. 28, 2000; the contents of which are incorporated herein by reference.

### FIELD OF THE INVENTION

The present invention relates to a vehicle seat sensor, and more particularly, to a vehicle seat sensor that has a flexible support.

### BACKGROUND OF THE INVENTION

In a conventional vehicle seat sensor, a thin sensor mat is mounted to a passenger's seat between the seat cushion and trim cover (facing). This sensor detects the presence, absence and physique of an occupant sitting on the passenger's seat according to the weight of the occupant on the seat portion. However, since the seat cushion and the trim cover of the seat portion have large variations in surface condition and hardness, the seat sensor has large variations in detected outputs. Further, since the seat sensor is a thin mat, as described above, the seat sensor may be bent by the seated person. Also, mounting the seat sensor inside the seat portion may result in poor mounting-positioning accuracy.

### SUMMARY OF THE INVENTION

The present invention provides a vehicle seat sensor which stabilizes the shape of a sensor mat by using a flexible and soft stabilizing member such as a foam sheet. A vehicle seat sensor includes a sensor mat positioned between a seat cushion and a trim cover of a seat portion, all parallel to the seating surfaces of the seat portion. A soft, flexible (and preferably smooth—such as a film material) stabilizing member is provided between the trim cover and the sensor mat. Here, the seat mat includes a plurality of sensor cells in matrix-like arrangement.

In another aspect, a sensor mat mounted between a seat heater and a seat cushion, parallel to the seating surface of the seat portion, and a soft, flexible (and preferably smooth—such as a film material) stabilizing member are provided between the trim cover and the sensor mat. Here, the sensor mat includes a plurality of sensor cells in matrix-like arrangement, and the seat heater is placed between the seat cushion and a trim cover of the seat portion of the vehicle seat. Further, the soft and flexible stabilizing member has heat insulating properties.

In another aspect of the invention, the vehicle seat sensor includes a second soft and flexible stabilizing member between the seat cushion and the shape stabilizing member.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is an exploded perspective view showing a seat sensor according to the present invention mounted inside a seat portion of a passenger's seat;

FIG. 2 is a sectional view taken along line 2-2 in FIG. 1; and

FIG. 3 is an exploded perspective view of the seat sensor according to the present invention.

### DETAILED DESCRIPTION OF THE INVENTION

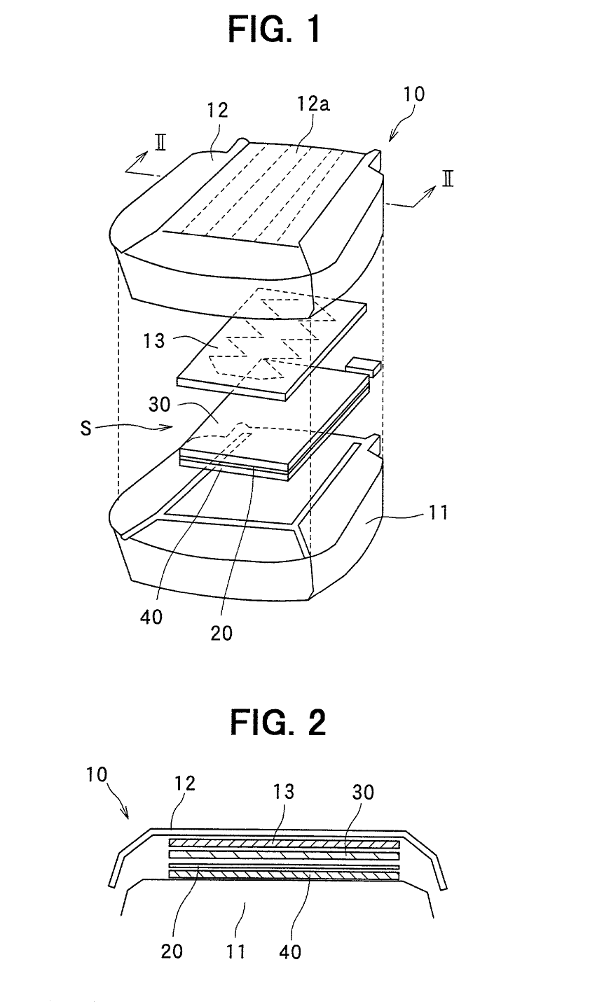

Hereinafter, the present invention will be described with reference to appended drawings. FIGS. 1 and 2 show a seat sensor S according to the present invention with a seat portion 10 of a vehicle passenger's seat. The seat portion 10 has a seat cushion 11, a trim cover 12 for covering the seat cushion, and a seat heater 13 disposed between the trim cover and the seat cushion. The seat heater 13 heats the seat portion 10.

As shown in FIGS. 1, 2, the seat sensor S is disposed between the seat heater 13 and the seat cushion 11 to be parallel to a seating surface (upper surface 12a of the trim cover 12). The seat sensor S is provided with a sensor mat 20, and both flexible and soft stabilizing members 30, 40 for sandwiching the sensor mat 20 therebetween.

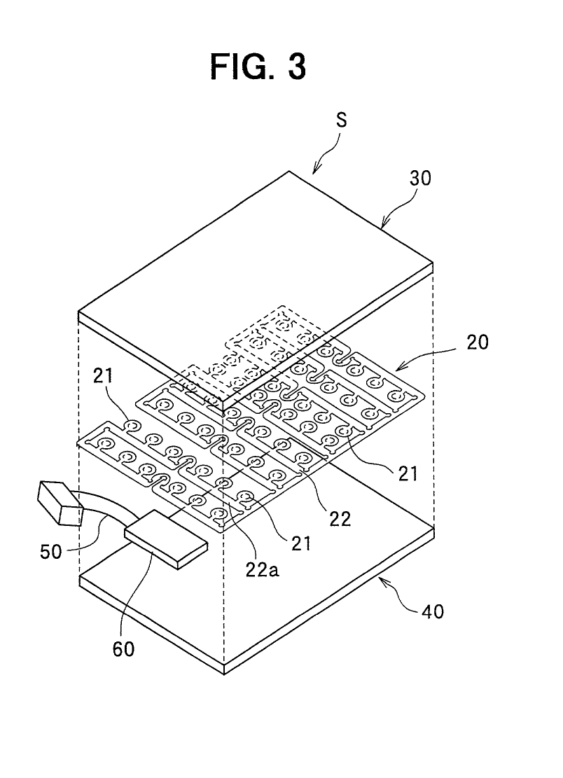

The sensor mat 20 preferably is made of a thin film, and is integrally formed with plural sensor cells 21 and a cell supporting portion 22 for supporting each sensor cell 21 (refer to FIG. 3). The cell supporting portion 22 is constructed by placing spacers between both resin films so that plural bars of strip portions 22a, which are parallel to one another, are connected to each other at their ends. In FIG. 3, the sensor cells 21 are shown without the spacers between the resin films. The same number of sensor cells 21 are formed integrated with each strip portion 22a and are separated from each other. Thereby, sensor cells 21 are disposed over the seating surface of the seat portion 10 in matrix-like arrangement.

In a seat sensor 20 constructed in such a manner, the sensor cells 21 are pressed by the weight of an occupant sitting on the seating surface of the seat portion 10, thereby detecting the weight. If a child seat is placed on the seating surface of the seat portion 10, the seat sensor 20 detects the weight of the child seat.

Each of the stabilizing members 30, 40 is preferably formed of a soft and flexible heat insulating material having a thickness of preferably 1 to 30 mm. Such material can be a thin urethane foam. The stabilizing members 30, 40 are uniformly fixed to both surfaces of the sensor mat 20 by an adhesive. The outer surface of the stabilizing member 30 is positioned close to the rear surface of the seat heater 13, and the outer surface of the shape stabilizing member 40 is proximate the surface of the seat cushion 11. The seat sensor is provided with an electronic control unit 60 connected to each sensor cell 21 through a wire harness 50. Detected output signals from respective sensor cells 21 are input to the electronic control unit 60 through the wire harness 50, and the electronic control unit 60 determines the presence or absence of an occupant sitting on the seating surface.

In the present embodiment, the sensor mat is sandwiched between the film designed stabilizing members 30, 40. Here, each of the shape stabilizing members 30, 40 is formed of a soft material such as thin urethane foam, as described above. Accordingly, both the shape stabilizing members 30, 40 flex and absorb shape variations and hardness of the seat cushion 11 and the trim cover 12. That is, pressures and bending loads, transmitted to the sensor mat 20 from the seat cushion 11 and the trim cover 12, can be made uniform through both the shape stabilizing members 30, 40. This means that the shape of the sensor mat 20 is kept stabilized.

By improving the position accuracy of the seat sensor S inside the seat portion 10, as described above, the seat sensor S can accurately detect the weight of the occupant sitting on the seating surface of the seat portion 10 in plane-like through each sensor cell 21.

Since the shape stabilizing member 30 is placed between the seat heater 13 and the sensor mat 20, as described above, the heat energy transmittance from the seat heater 13 to the sensor mat 20 can be interrupted by using the heat insulation properties of the shape stabilizing member 30. Thereby, the temperature characteristics and durability of the sensor mat 20 of the seat sensor S are improved.

As a note, the seat heater 13 is not require and can be eliminated. Also, one of the shape stabilizing members 30, 40 can be eliminated. The material of the shape stabilizing members 30, 40 can be rubber sponge, non-woven fabrics, or fabrics or cotton other than urethane foam. Each of the shape stabilizing members 30, 40 can be formed so that holes are partly provided therein. The seat sensor can be generally mounted inside a seat portion of a vehicle seat without being limited to a passenger car.

While the above-described embodiments refer to examples of usage of the present invention, it is understood that the present invention may be applied to other usage, modifications and variations of the same, and is not limited to the disclosure provided herein.

1. A vehicle seat sensor comprising:
a sensor mat mounted between a seat cushion and a trim cover of a seat portion of a vehicle seat, said sensor mat being parallel to a seating surface of the seat portion, the sensor mat including a plurality of sensor cells oriented in a matrix-like arrangement; and
a soft and flexible stabilizing member provided between the trim cover and the sensor mat.

2. A vehicle seat sensor comprising:
a sensor mat mounted between a seat heater and a seat cushion, said sensor mat positioned parallel to a seating surface of a seat portion, the sensor mat including a plurality of sensor cells in matrix-like arrangement, a seat heater being placed between the seat cushion and a trim cover of the seat portion; and
a soft and flexible stabilizing member provided between the trim cover and the sensor mat, stabilizing member being thermally insulating.

3. The vehicle seat sensor according to claim 1 or 2, wherein a second soft and flexible stabilizing member is provided between the seat cushion and the stabilizing member.

4. A vehicle seat sensor comprising:
a sensor mat having a plurality of sensor cells, each of said sensor cells electrically connected to a remainder of said plurality of sensor cells to output an electrical signal representative of a load on said sensor mat; and
a soft and flexible stabilizing member positioned on at least one side of said sensor mat to support said sensor mat.

5. A vehicle seat sensor as claimed in claim 4, further comprising a second soft and flexible stabilizing member being disposed on an opposite side of said sensor mat with respect to said stabilizing member, said stabilizing member and said second stabilizing member sandwiching said sensor mat to support said sensor mat.

6. A vehicle sensor as claimed in claim 5, further comprising an upper seat portion and a lower seat portion, said stabilizing member, said second stabilizing member and said sensor pad sandwiched between said upper seat portion and said lower seat portion to detect a load on said upper seat portion.

7. A vehicle sensor as claimed in claim 6, further comprising a heater disposed between an upper one of said stabilizing members and said seat portion.
